(19) United States
(12) Patent Application Publication
(10) Pub. No.: US 2026/0094101 A1
(43) Pub. Date: Apr. 2, 2026

(54) MACHINE LEARNING FRAMEWORK THAT EXTRACTS ACTIONABLE INSIGHTS FROM DISPARATE DATA SOURCES

(71) Applicant: Intuit Inc., Mountain View, CA (US)

(72) Inventors: Siddharth JAIN, Mountain View, CA (US); Sivashanker THIRUCHITTAMPALAM, Toronto (CA); Venkat Narayan VEDAM, Mountain View, CA (US); Jonathan LIN, Toronto (CA)

(73) Assignee: Intuit Inc., Mountain View, CA (US)

(21) Appl. No.: 18/902,874

(22) Filed: Sep. 30, 2024

(51) Int. Cl. G06Q 10/0637; G06F 16/248; G06F 16/25

(52) U.S. Cl. CPC G06Q 10/06375; G06F 16/248; G06F 16/258

(57) ABSTRACT

Machine learning framework that extracts actionable insights from disparate data sources include performing operations. A merged feature set is generated by collecting diverse data to generate aggregated data in a unified dataset and performing an autoencoding of the aggregated data to generate compressed data in a low-dimensional latent space. The merged feature set is further generated by merging the first attribute and the second attribute to obtain a merged feature set for the low-dimensional latent space. The operations include selecting a response vector from the merged feature set in the low-dimensional latent space that is aligned with a user query, decoding the response vector into natural language text, executing a large language mode (LLM) to the natural language text and the user query to generate an actionable insight.

### BACKGROUND

Organizations create an access large volumes of data. Management of the data is performed by data management systems. The data management systems may obtain data from a large number of sources and combine the data into a knowledgebase. Generally, the combination is performed using data extraction techniques that attempt to match predefined field names to keywords in the data and then identify the values corresponding to the keywords. The resulting key value pairs are stored. Thus, the extracted data is explicitly found in the data source.

A challenge exists in that the various data sources are disparate. The disparate data sources may be due to the type and location of the source, the various formats of the data (e.g., structured, semi-structured, or unstructured formats), the data types of the data, and other properties about the data source or the data. The lack of cohesiveness of the data may result in ineffectual combining of the data. Namely, the process of data extraction and integration is generally limited to only that which is explicitly found in the data sources and have predefined linkage to a common format (e.g., common key value pairs).

The technical problem is that computing systems do not fully extract and integrate data from disparate sources in a manner that enables analysis of the data, for example, to generate responses to queries.

### SUMMARY

In general, in one aspect, one or more embodiments relate to a method that includes using a merged feature set. Generating the merged feature set includes collecting diverse data to generate aggregated data in a unified dataset. The diverse data includes first data from a first source and second data from a second source, the second source being disparate from the first source, the first data having a first attribute, and the second data having a second attribute. Generating the merged feature set further includes performing an autoencoding of the aggregated data to generate compressed data in a low-dimensional latent space. The compressed data are representations of the aggregated data in the low-dimensional latent space. Generating the merged feature set includes merging the first attribute and the second attribute to obtain a merged feature set for the low-dimensional latent space. The method includes selecting a response vector from the merged feature set in the low-dimensional latent space that is aligned with a user query, decoding the response vector into natural language text, executing a large language mode (LLM) to the natural language text and the user query to generate an actionable insight. The method further includes presenting the actionable insight as a response to the user query.

In general, in one aspect, one or more embodiments relate to a system. The system includes a server including a processor, a data repository in communication with the processor, and configured to store diverse data comprising first data from a first source and second data from a second source, the second source being disparate from the first source, the first data having a first attribute, and the second data having a second attribute, compressed data in a low-dimensional latent space, and a merged feature set for the low-dimensional latent space. The system further includes a large language mode (LLM), wherein the processor is programmed to apply the LLM to the natural language text and a user query to generate the actionable insight, an autoencoder, wherein the processor is programmed to apply the autoencoder to data to generate representations of the data in the low-dimensional latent space, and a server controller executable by the processor to perform operations to generate a merged feature set. Generating the merged feature set includes collecting the diverse data to generate aggregated data in a unified dataset, performing an autoencoding of the aggregated data to generate the compressed data, merging the first attribute and the second attribute to obtain the merged feature set. The operations include selecting a response vector from the merged feature set in the low-dimensional latent space that is aligned with a user query, decoding the response vector into the natural language text, executing the LLM on the natural language text and the user query to generate actionable insight, and presenting the actionable insight as a response to the user query.

In general, in one aspect, one or more embodiments relate to a non-transitory computer readable storage medium storing computer readable program code which, when executed by at least one processor, cause the at least one processor to perform operations using a merged feature set. Generating the merged feature set includes collecting diverse data to generate aggregated data in a unified dataset. The diverse data includes first data from a first source and second data from a second source, the second source being disparate from the first source, the first data having a first attribute, and the second data having a second attribute. Generating the merged feature set further includes performing an autoencoding of the aggregated data to generate compressed data in a low-dimensional latent space. The compressed data are representations of the aggregated data in the low-dimensional latent space. Generating the merged feature set further includes merging the first attribute and the second attribute to obtain a merged feature set for the low-dimensional latent space. The operations include selecting a response vector from the merged feature set in the low-dimensional latent space that is aligned with a user query, decoding the response vector into natural language text, executing a large language mode (LLM) to the natural language text and the user query to generate an actionable insight. The operations further include presenting the actionable insight as a response to the user query.

Other aspects of one or more embodiments will be apparent from the following description and the appended claims.

### BRIEF DESCRIPTION OF DRAWINGS

FIG. 1 and FIG. 2 show a computing system, in accordance with one or more embodiments.

FIG. 3 shows a flowchart of a method for extracting actionable insights from disparate data sources, in accordance with one or more embodiments.

FIG. 4 and FIG. 5 show an example of extracting actionable insights from disparate data sources in accordance with one or more embodiments.

FIG. 6A and FIG. 6B show an example of a computing system and network environment in accordance with one or more embodiments.

Like elements in the various figures are denoted by like reference numerals for consistency.

### DETAILED DESCRIPTION

One or more embodiments are directed to extracting actionable insights from disparate data sources. Actionable insight refers to a piece of discernible information derived from data that directly informs decision-making processes. The actionable insight may originate from a single data source or from an integration of multiple data sources. Embodiments support both types of actionable insights. Generally, integrating data from disparate sources into a cohesive analytical framework is a challenge because of the wide variety of source data and some of the information does not directly match to keyword-based extraction techniques.

The vast volume and diversity of source data managed by organizations create severe challenges. The source data may originate from structured databases, semi-structured logs and XML files, and unstructured sources like digital interactions and sensor networks. The diverse data sources, often siloed and lacking interconnection, present substantial hurdles when integrating the source data into a cohesive analytical framework for deriving actionable insights. The high-dimensional and discrete nature of the scattered data complicates the creation of meaningful relationships across datasets and comprehensive analysis.

To address the above challenges, one or more embodiments have an autoencoder that encodes aggregated data from the disparate data sources. The autoencoder generates compressed data in a low-dimensional latent space. Feature blending is performed when the data is in the low-dimensional latent space to combine the attributes of the data while the attributes are in low dimensional latent space. When a query is received, a response vector from the lower dimensional latent space that is aligned to the query is identified and decoded. Then, a large language model is executed on the response vector to generate emergent information. The integration of the various models and the performance in low dimensional latent space simplifies data complexity, ensures comprehensive analysis by blending diverse data attributes, and enables precise insight extraction aligned with user queries.

More specifically, the computing system aggregates data from multiple sources into a unified repository. The aggregated data is compressed into a low-dimensional, continuous latent space by generated encoded vectors representing the aggregated data. Additionally, the attributes from the various data sources are merged to enhance analytical depth. In response to a user query, the computing system selects data points that match the user query. The selected data points are used to select encoded vectors which are then translated into natural language text. An LLM is applied to the natural language text and the user query to derive insights, such as an answer to the query.

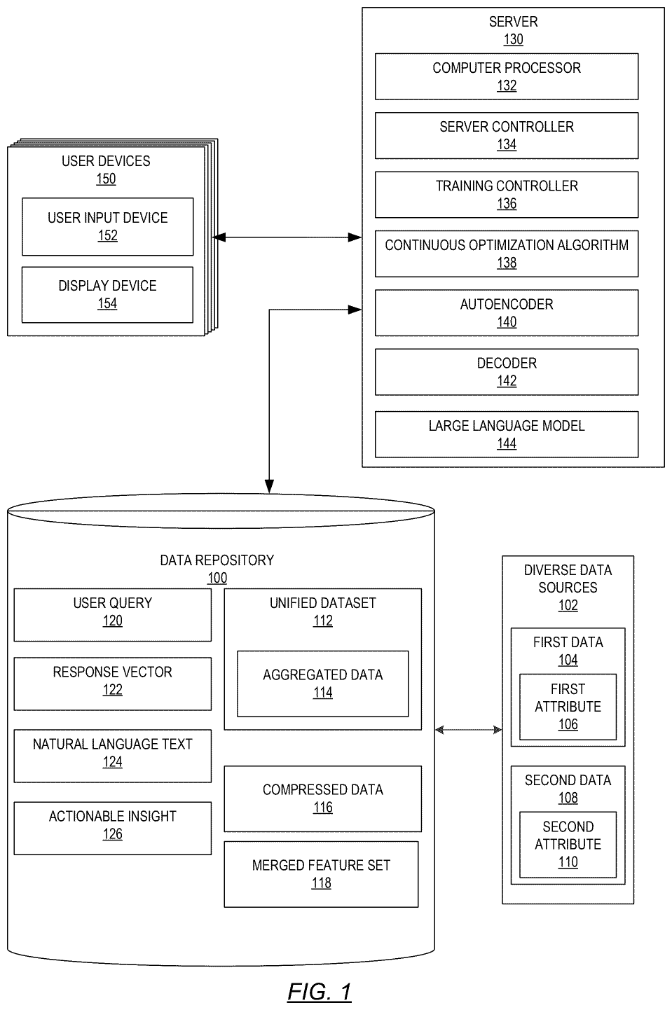

Attention is now turned to the figures. FIG. 1 shows a computing system, in accordance with one or more embodiments. The system shown in FIG. 1 includes or is connected to diverse data sources. The diverse data sources (102) includes at least first data (104) from a first source and second data (108) from a disparate, second source. Although only two data (e.g., first data (104), second data (108)) items are disclosed, more than two data items generally exist. Each piece of data is from a disparate data source. For example, the data sources may include various websites, public and private databases, log file repositories, and other types of data sources. The various data may also be diverse in type, formatting, file type, whether structured, unstructured, or semi-structured, communication mode (e.g., text, image, video), level of human interpretability of the data. For example, the data may include developer documents, collaborative websites that store content, structured forms and other structured documents, unstructured documents, log files, user postings from user forums, and other types of data that is stored in a digital format. For example, the first data (104) and second data (108) may be files, documents, records, or other information stored in a digital format. The data has attributes. The attributes are individual pieces of metadata about the data. As such, the attributes may be referred to as metadata attributes. For example, the metadata attributes of the data may include filename, data source name, file type, format of the data, layout of the data, file size, and other attributes. As shown in FIG. 1, the first data (104) has a first attribute (106) and the second data (108) has a second attribute (110). The second attribute (108) may be the same or different from the first attribute (106).

The diverse data sources (102) are connected to a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) is configured store a unified dataset (112) having aggregated data (114). The aggregated data (114) includes the first data (104) and second data (108). The aggregation may be that the data is in a single store or that the data is correlated.

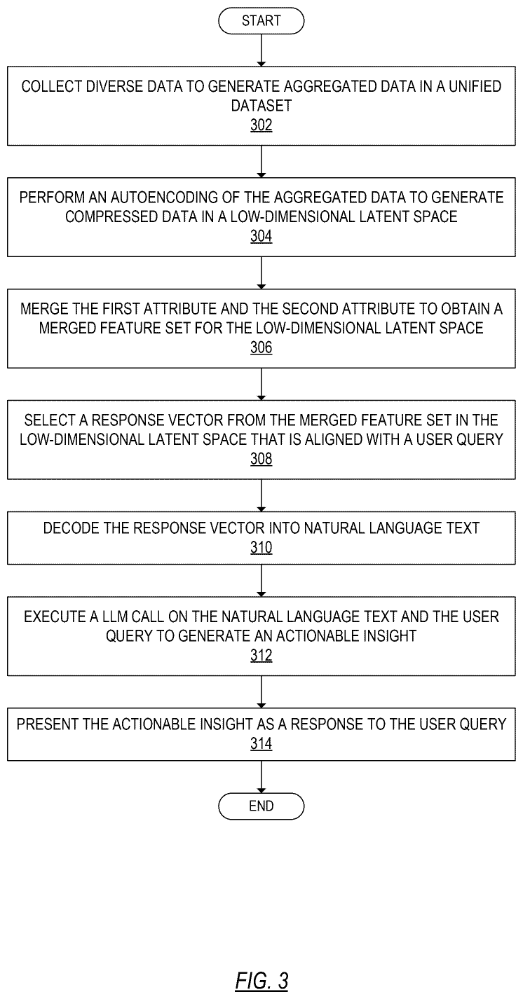

The data repository (100) may also be configured to store compressed data (116). The compressed data (116) includes vector representations of the aggregated data (114) in a low-dimensional latent space. Latent space is lower-dimensional representation of higher-dimensional data. For example, natural language text has semantic meaning derived from the individual words as well as how the words are combined to form sentences. Similarly, other types of data, such as images and video, may be in a higher dimensional latent space whereby meaning is derived from data elements in relation to each other. Direct vector encoding does not change the dimensionality of the data. The lower dimensional latent space encodes the semantic meaning of the data. The compressed data (116) may be generated by applying an autoencoder (140) to the aggregated data (114), as described with respect to FIG. 3. The low-dimensional space is a form of data that a processor may process (e.g., data expressed in binary format).

The data repository (100) also stores a merged feature set (118). The merged feature set (118) are features from the compressed data (116) that are merged into combined features. The combination of features is a mathematical based combination that includes features determined from the first attribute and features determined from the second attribute.

The data repository (100) may be configured to receive and store a user query (120). The user query (120) is alphanumeric text or special characters received from a user device, such as the user devices (150) defined below, or some other computing process. The user query (120) is a request for information.

The data repository (100) also stores a response vector (122). The response vector (122) represents responsive information from the aggregated data (114) in the low dimensional space. The response vector (122) may be a vector which is determined to be substantially similar to a mapping of the user query (102) to the low-dimensional space. For example, the response vector may be a vector that is within a threshold distance to the user query. Multiple response vectors may be included, each response vector being within the threshold distance.

The data repository (100) may store natural language text (124). The natural language text (124) is alphanumeric text or special characters that is a decoding of the response vector (122), as described with respect to FIG. 3.

The data repository (100) also stores actionable insights (126). Actionable insights are emergent information generated from the combination of data and metadata in the diverse data sources. Namely, actionable insights are not information found in any particular data source, but rather information found in a combination of data sources including the metadata of the diverse data. Actionable insights are generated by the large language model for the user query. The actionable insight (126) may include alphanumeric text or special characters. In one or more embodiments, actionable insights (126) are in natural language. The actionable insight (126) may have been generated to find the information specified in the user query (120). The actionable insight (126) may be generated by applying a large language model (144) to the natural language text (124) and the user query (120), as described with respect to FIG. 3.

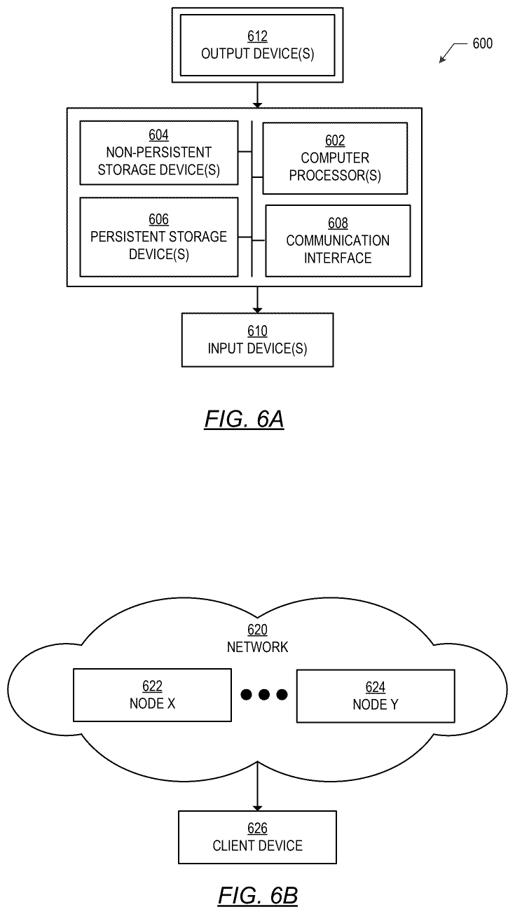

The system shown in FIG. 1 may include other components. For example, the system shown in FIG. 1 also may include a server (130). The server (130) is one or more computer processors, data repositories, communication devices, and supporting hardware and software. The server (130) may be in a distributed computing environment. The server (130) is configured to execute one or more applications, such as the training controller (136), the continuous optimization algorithm (138), the autoencoder (140), the decoder (142), and the large language model (144). An example of a computer system and network that may form the server (130) is described with respect to FIG. 6A and FIG. 6B.

The server (130) includes a computer processor (132). The computer processor (132) is one or more hardware or virtual processors which may execute computer readable program code that defines one or more applications, such as the training controller (136), the continuous optimization algorithm (138), the autoencoder (140), the decoder (142), and the large language model (144). An example of the computer processor (132) is described with respect to the computer processor(s) (502) of FIG. 6A.

The server (130) also may include a server controller (134). The server controller (134) is software or hardware programmed to coordinate execution of one or more of the training controller (136), the continuous optimization algorithm (138), autoencoder (140), decoder (142), or the large language model (144). The server controller (134) also may be software or hardware programmed to cause the processor (132) to execute one or more steps of the method of FIG. 3.

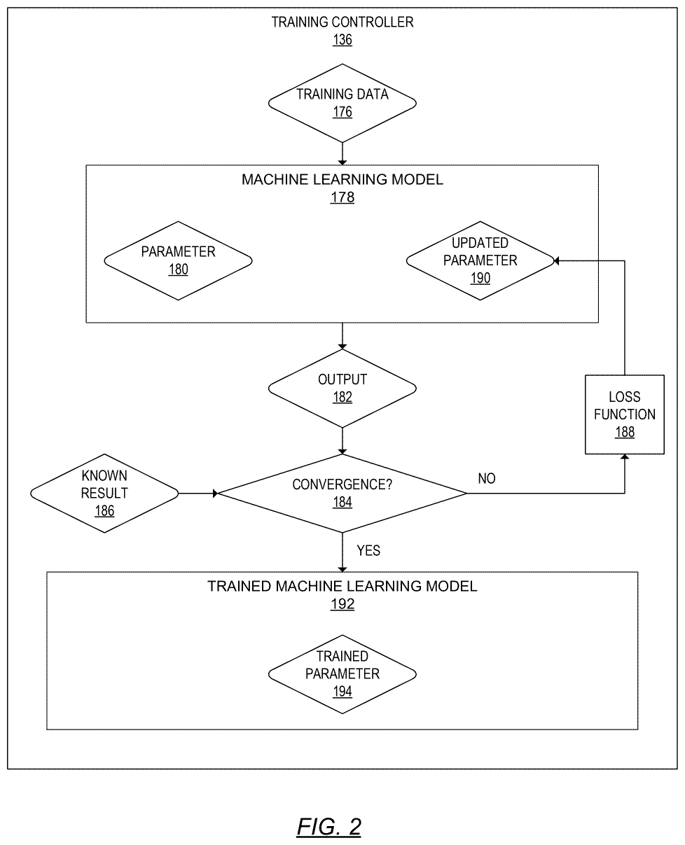

The server (130) also may include a training controller (136). The training controller (136) is software or application specific hardware which, when executed by the computer processor (132), trains one or more machine learning models (e.g., the large language model (144) and the autoencoder (140)). The training controller (136) is described in more detail with respect to FIG. 2.

The server (130) also includes a continuous optimization algorithm (138). The continuous optimization algorithm (138) is software or hardware that identifies relevant regions within the low-dimensional space based on a query, such as a user query (120). The continuous optimization algorithm (138) may take as input a user query (120) and compressed data (116) in order to identify one or more vectors from the compressed data (116) located in the relevant regions. Use of the continuous optimization algorithm (138) is described with respect to FIG. 3.

The server (130) also includes an autoencoder (140). The autoencoder (140) is software or hardware that generates vector representations of data in a compressed format (i.e., the compressed data (116)). The autoencoder (140) may take data as input, such as the aggregated data (114). Use of the autoencoder (140) is described with respect to FIG. 3.

The server (130) also includes a decoder (142). The decoder (142) is software or hardware that generates natural language, such as natural language text (124), of a vector, such as response vector (122). The decoder (142) may take data as a response vector (122). Use of the decoder (142) is described with respect to FIG. 3.

The server (130) also includes a large language model (144). The large language model (144) is a natural language processing machine learning model. Large language models are artificial intelligence systems capable of understanding and generating human language by processing vast amounts of text data. In one or more embodiments, the large language model (144) may be a commercially available LLM, for example, ChatGPT® from OpenAI, Llama®, Claude®, Mistral-7B, etc. In other embodiments, the large language model (144) may be a custom-built large language model, including a foundation model and additional customizing implementation. However, the large language model (144) may be other types of language models. Use of the large language model (144) is described with respect to FIG. 3.

FIG. 1 also shows one or more user devices (150). The user devices (150) are the computing systems which users use to submit the user query (102). The user devices (150) may include a mouse, keyboard, microphone, touch screen, haptic device, etc., with which the user may interact. Thus, the user devices (150) are computing systems, which a user may use to interact with the server (130). For example, the user query (120) may be received from one or more of the user devices (150), as described in step 302 of FIG. 3.

In many cases, the user devices (150) are not part of a system owned or operated by the entity that owns or operates the server (130). Such user devices (150) may be referred to as “remote” devices, and thus may not be part of the system of FIG. 1. However, one or more of the user devices (150) may be part of the same system of which the server (130) is a part. In this case, such user devices (150) may be referred to as “local” devices, even if the user devices (150) are not in the same physical geographical location. Local devices may be considered part of the system shown in FIG. 1.

The user devices (150) may include a user input device (152) and a display device (154), as described in more detail with respect to FIG. 6A.

While FIG. 1 shows a configuration of components, other configurations may be used without departing from the scope of one or more embodiments. For example, various components may be combined to create a single component. As another example, the functionality performed by a single component may be performed by two or more components.

Attention is turned to FIG. 2, which shows the details of the training controller (136). The training controller (136) is a training algorithm, implemented as software or application specific hardware, that may be used to train one or more of the machine learning models described, with respect to the computing system of FIG. 2.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some pre-determined amount, or until some other termination condition occurs. After training, the final adjusted model is applied to unknown data (i.e., a query for which the actual resulting vector is not known) in order to make a vector.

Some machine learning models may be applied to vector data structures. A vector is a computer readable data structure. A vector may take the form of a matrix, an array, a graph, or some other data structure. However, a frequently used vector form is a one by N matrix, where each cell of the matrix represents the value for one feature. As described above, a feature is a topic of data (e.g., a color of an object, the presence of a word or alphanumeric text, a physical measurement type, etc.). A value is a numerical or other recorded specification of the feature. For example, if the feature is the word “cat,” and the word “cat” is present in a corpus of text, then the value of the feature may be “1” (to indicate a presence of the feature in the corpus of text).

In one or more embodiments, some of the data in the data repository (100) of FIG. 1 may be stored in the form of one or more vectors. For example, the response vector (122) may be expressed as a vector. Similarly, the aggregated data (114) may be converted from natural language into vectors as part of executing the autoencoder (140).

Returning to the operation of the training controller (136), training starts with training data (176), which may be expressed in vector form. The training data (176) may include data from FIG. 1, expressed in vector form.

For training autoencoders, autoencoders are neural networks designed to learn efficient codings of input data, such as for the purpose of dimensionality reduction or feature learning. The autoencoders include an encoder model and a decoder model. The encoder model reduces the dimensionality, tailoring the network to capture essential domain-specific features. The decoder model decodes the domain specific features into an embedding. Autoencoders may be trained using the technique described below, including data collection and aggregation, pre-processing and normalization.

The training data (176) may be labeled. The labels represent a known result. Thus, a label applied to a query may indicate the expected vector to be generated.

Thus, the training data (176) may be data for which the final result is known with certainty. For example, when the autoencoder (140) is called during training to process data, the autoencoder (140) generates the vector in a low-dimensional, embedded-vector space. However, the label on the data is the expected vector—the resulting vector that is known to be correct. If the prediction does not match the label, then the weights of the layers may be updated, and the training process iterated.

More generally, the training data (176) is provided as input to the machine learning model (178), which may be the autoencoder (140) of FIG. 1. The machine learning model (178) may be characterized as a program that has adjustable parameters. The program is capable of learning and recognizing patterns to make predictions. The output of the machine learning model (178) may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) provided goes through a convergence process (184). The convergence process (184) is programmed to achieve convergence during the training process. Convergence is a state of the training process, described below, in which a pre-determined end condition of training has been reached. The pre-determined end condition may vary based on the type of machine learning model (178) being used (supervised versus unsupervised machine learning), or may be pre-determined by a user (e.g., convergence occurs after a set number of training iterations, described below).

In the case of supervised machine learning (e.g., the autoencoder (140) of FIG. 1), the convergence process (184) compares the output (182) to a known result (186). The known result (186) is stored in the form of labels for the training data (176). For example, the known result (186) for a particular entry in an output (182) vector of the machine learning model (178) may be a known value and that known value is a label that is associated with the training data (176).

Continuing the example of supervised machine learning model training, a determination is made whether the output (182) matches the known result (186) to a pre-determined degree. The pre-determined degree may be an exact match, a match to within a pre-specified percentage, or some other metric for evaluating how closely the output (182) matches the known result (186). Convergence may occur when the known result (186) matches the output (182) to within a pre-specified percentage. When many predictions are involved, then convergence may occur when more than a threshold number of predictions correctly match the corresponding labels.

For example, the threshold may be 95%. In this case, when the autoencoder's (140) accuracy reaches 95% (representing, that in 95 times out of 100 query vectors the autoencoder (140) correctly generates) then convergence occurs.

In the case of unsupervised machine learning, the convergence process (184) may be compared to the output (182) or to a prior output in order to determine a degree to which the current output changed relative to the immediately prior output or to the original output. Once the degree of change fails to satisfy the threshold degree of change, then the machine learning model may be considered to have achieved convergence. Alternatively, an unsupervised model may determine pseudo labels be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188). The program may be an algorithm which attempts to guess how the parameter (180) may be changed so that the next execution of the machine learning model (178), using the training data (176) with the updated parameter (190), will have an output (182) that is more likely to result in convergence. In this manner, the next execution of the machine learning model (178) is more likely to match the known result (186) (supervised learning), or which is more likely to result in an output (182) that more closely approximates the prior output (one unsupervised learning technique), or which otherwise is more likely to result in convergence.

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 2 may be multiple parameters, weights, settings, etc.

During deployment, the trained machine learning model (192) with the trained parameter (194) is executed again, but this time on unknown data (which may be in the form of an unknown data vector) for which the final result is not known. The output of the trained machine learning model (192) is then treated as the generated vector relative to the unknown data.

FIG. 3 shows a flowchart of a method for extracting actionable insights from disparate data sources, in accordance with one or more embodiments. The method of FIG. 3 may be implemented using the system of FIG. 1 and one or more of the steps may be performed on or received at one or more computer processors.

Step 302 includes collecting diverse data to generate aggregated data in a unified dataset. The diverse data can come from multiple sources, such as, first data from a first data source and second data from a second data source. Additional data may be gathered from other data sources. The data sources may be disparate and use different formats, for example, date formats. Some of the data may be streaming data pushed from the data sources, other data may be acquired by querying different data sources using the application programming interfaces (APIs) of the different data sources.

The data from the various data sources are compiled and aggregated into a unified dataset. Aggregate structured data from multiple databases can harvest rich, actionable information from technical sources. The data may be pre-processed, for example, to remove inaccuracies, duplicates, and irrelevant entries to enhance data quality and reliability. The data may be converted to align semi-structured data with structured datasets. For example, unstructured data is parsed to extract values and convert the data into a structured format. Parsing techniques can convert semi-structured data into a structured format, for example, by using hierarchical markdown parsing for XML to extract nested structures and attributes, key-value parsing for JSON, and extracting structure from metadata attributes. The aggregated data may also include the metadata attributes extracted from the data sources.

Step 304 includes performing an autoencoding of the aggregated data to generate compressed data into a low-dimensional latent space. The autoencoder compresses the high-dimensional data, D′, into a low-dimensional latent representation, Z. The low-dimensional latent representation, Z, of the data may be expressed as:

$$Z = σ ( {W}_{e} \cdot {D}^{′} + {b}_{e} )$$

Where Wₑ and bₑ are the weights and biases of the encoder, respectively, and o is a non-linear activation function.

Dimensionality reduction via autoencoders simplifies the structured datasets by transforming the data into a condensed, low-dimensional, continuous latent space representation. The autoencoder generates an efficient encoding of the data. By doing so, the autoencoder captures the essence and critical features of the dataset, distilling vast amounts of information into a more manageable form without significant loss of detail or relevance.

Step 306 includes merging the first attribute and the second attribute to obtain a merged feature set for the low-dimensional latent space. Feature blending may be expressed as:

$${Z}^{′} = {\sum }_{i = 1}^{m} {w}_{i} \cdot σ ( {W}_{b i} \cdot Z + {b}_{b i} )$$

Here, W_{bi} and b_{bi} represent the weights and biases for the blending operations of different feature sets within Z. The blending weights are w; and m is the number of distinct feature sets being integrated. Feature blending models the blending as a weighted sum of transformed features. Each transformation could involve a distinct network or transformation logic tailored to specific types of data.

Applying feature blending within the latent space enhances the dataset's analytical depth by integrating attributes from diverse data sources. In the low-level latent space, the attributes are expressed as features. The process of feature blending may preserve unique characteristics of the data and while also having overarching patterns. Preservation of unique characteristics ensures that the distinct insights and patterns inherent to each data source are maintained. The preservation retains the richness and context-specific nuances of the data. By merging attributes through feature blending across data sources in the low dimensional latent space, patterns and relationships that span different datasets are captured. The holistic perspective enriches the dataset with comprehensive insights that become visible when disparate data elements are viewed in conjunction. Once a reduced feature set is identified, processes like Gaussian process regression (GPR) and automatic relevance determination (ARD) kernel can be applied to further determine the relevance of the different features.

In Step 308, at least one response vector aligned with a user query is selected. A user query is received, such as from a user level application, a website, or other interface. The user query is passed to the system that converts the user query to be in the same low-dimensional latent space as the data from the data sources. The vector for the user query is then compared to feature vectors in the low-dimensional latent space to identify a set of feature vectors. Selecting the response vector may be performed to find a set of closest vectors in lower dimensional space for the user query. Similarity distance metric algorithms like cosine similarity, Euclidean distance, hamming distance, etc. or even a custom distance metric to find the closest vectors.

In one or more embodiments, Step 308 includes performing multiple operations. For example, Step 308 may include identifying a region of the low-dimensional latent space aligned with a user query.

The selection may be expressed as:

$${Z}^{′} = \{ arg {MIN}_{z ∈ {Z}^{′}} C ( z , Q ) \}$$

The optimization locates a set of vectors Z″ within Z′ that minimizes the cost function C, based on similarity metrics relevant to the query, Q.

In the continuous latent space, points in close proximity are also semantically similar. The continuous optimization algorithm, which may include gradient descent, Adam, and/or Bayesian optimization, efficiently navigates towards regions that align with a user-defined query. Utilizing similarity metrics like cosine similarity, the continuous optimization algorithm leverages the structured nature of the space to quickly identify vectors that encapsulate the query's intent.

A response vector may be selected from the region of the low-dimensional latent space based on the merged feature set. The response vector (or multiple response vectors) may be a limited set of vectors deemed closest to a vector representation of the user query, in the low-dimensional latent space.

Step 310 includes decoding the response vector into natural language text. The decoding is an embedding inversion technique that decodes the identified vector from the lower-dimensional latent space into higher-dimensional, discrete text. A transformer model may be applied to decode the response vector. The decoding accurately translates the complex, encoded data into an interpretable and actionable form. A set of response vectors may be decoded. Each response vector may be individually decoded into corresponding natural language text.

Step 312 includes executing a large language model call on the natural language text and the user query to generate actionable insight. The system concatenates the decoded text and the query into a prompt. The prompt is for the LLM and is sent to the LLM via a LLM call. The input stream may also include a prompt which is formatted or encoded in a way that is compatible with textual data. The LLM processes the LLM call by processing the prompt.

After embedding inversion translates the encoded data from the latent space into discrete text forming context for the user query, the context is combined with the user's original query for processing by LLMs. This approach utilizes the LLM's capacity for understanding of natural language to derive nuanced insights from the provided context.

The context size is reduced due to the dimensionality reduction of the latent space and feature blending. The condensed context may be free from constraints of input token size limitations in LLMs, allows for a focused and efficient analysis. The LLM leverages the input to perform a contextual interpretation, aligning closely with the specific parameters of the query.

Step 314 includes presenting the actionable insight as a response to the user query. The response may be sent to a user device for display or further processed by the computing system. For example, the actionable insight may be displayed to a user in a user interface.

While the various steps in this flowchart are presented and described sequentially, at least some of the steps may be executed in different orders, may be combined or omitted, and at least some of the steps may be executed in parallel. Furthermore, the steps may be performed actively or passively.

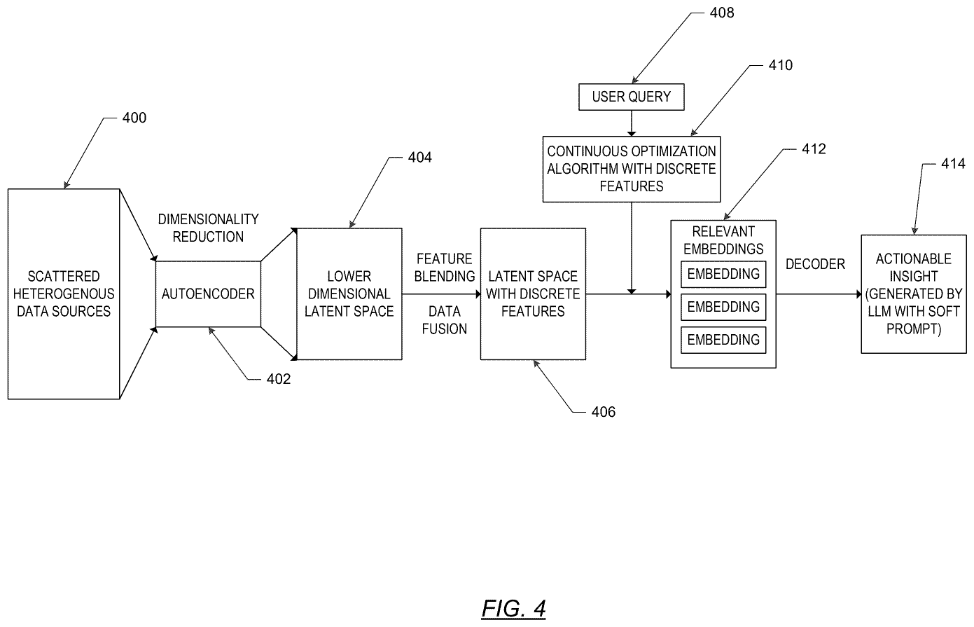

FIG. 4 shows an example of extracting actionable insights from disparate data sources in accordance with an embodiment. As shown, scattered heterogenous data sources (400) are provided to an autoencoder (402) to generate vector representations of the data. The autoencoder (402) provides dimensionality reduction to the data.

The vector representations create a lower-dimensional latent space (404).

The lower-dimensional latent space (404) is provided with feature blending and data fusion to identify latent space with discrete features (406).

When the computing system receives a user query (408), a continuous optimization algorithm (410) is called with discrete features from the user query. The continuous optimization algorithm (410) locates relevant embeddings (412) from the lower-dimensional latent space (404).

The relevant embeddings (412) are provided to a decoder which enables the generation of actionable insights (414). An LLM may be applied to the decoded embeddings to generate the actionable insights (414).

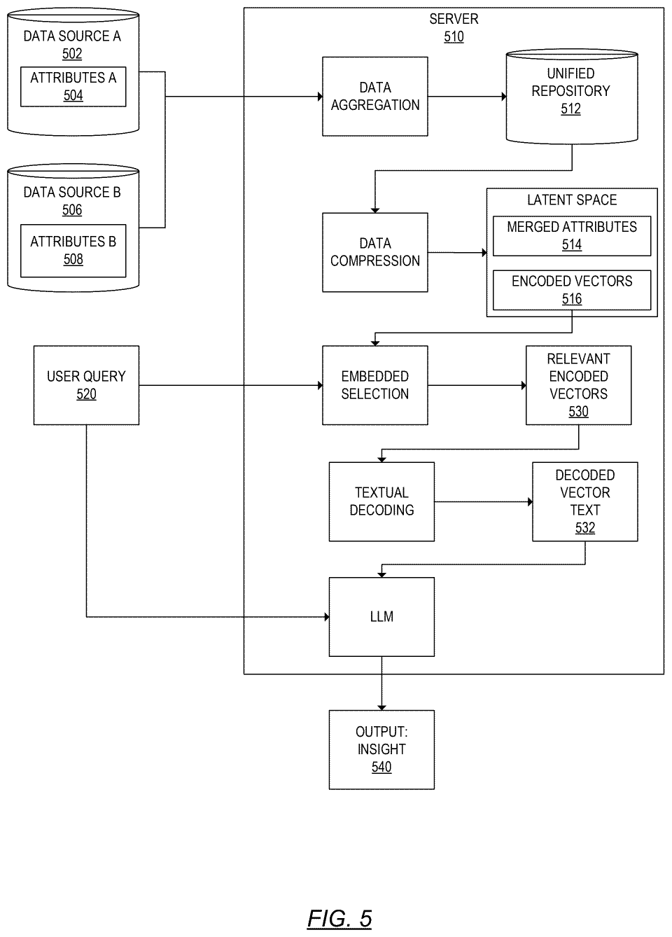

FIG. 5 shows another example of extracting actionable insights from disparate data sources in accordance with an embodiment. The system includes two data sources, data source A (502) which has attributes A (504) and data source B (506) which has attributes B (508). The data from data source A (502) and data source B (506) are provided to the server (510). For example, data source A (502) may be “Michigan Cicada XIX” data and include data “17-year brood cycle, Last brood 2007” and data source B (508) may be “Illinois Cicada XIII” data and include data “13-year brood cycle, Next brood 2024”.

The server (510) uses data aggregation to process the data from data source A (502) and data source B (506) and combine the data into a unified repository (512), for example, by eliminating inaccuracies and duplicate data. The data may be reformatted to use similar attributes when aggregated. For example, Illinois Cicada XIII″ data may be reformatted to be “13-year brood cycle, Last brood 2011”.

The server (510) applies data compression to the data in the unified repository (512) to generate encoded vectors (516) which define a latent space. The latent space, a low-dimensional representation of the data, is also defined by merged attributes (514) from the data. The merged attributes (514) indicate the attributes from attributes A (504) and attributes B (508) which are used in the unified repository (512).

The server (510) may receive a user query (520) requesting information or actionable data from the server (510). The server (510) may use the user query (520) to identify relevant encoded vectors (530). The relevant encoded vectors (530) may be those closest to a vector representation of the user query (520) in the latent space.

The server (510) applies a textual decoding to the relevant encoded vectors (530) to generate decoded vector text (532). The user query (520) and the decoded vector text (532) is used by an LLM to generate insight (540), which is provided as output. For example, in response to a query asking “When will Cicada XIX and Cicada XIII brood together?”, the output may be “Cicada XIX and Cicada XIII will brood together in 2024”.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
selecting a response vector from a merged feature set in a low-dimensional latent space that is aligned with a user query, wherein the merged feature set is generated by:
collecting diverse data to generate aggregated data in a unified dataset, wherein the diverse data comprises first data from a first source and second data from a second source, the second source being disparate from the first source, the first data having a first attribute, and the second data having a second attribute,
performing an autoencoding of the aggregated data to generate compressed data in the low-dimensional latent space, wherein the compressed data are representations of the aggregated data in the low-dimensional latent space, and
merging the first attribute and the second attribute to obtain the merged feature set for the low-dimensional latent space;
decoding the response vector into natural language text;
executing a large language mode (LLM) to the natural language text and the user query to generate an actionable insight; and
presenting the actionable insight as a response to the user query.

2. The method of claim 1, wherein selecting the response vector comprises:
identifying a region of the low-dimensional latent space aligned with the user query; and
selecting the response vector from the region of the low-dimensional latent space based on the merged feature set.

3. The method of claim 2, further comprising:
selecting responsive compressed data in the region, the responsive compressed data being identified as similar to the user query based on the merged feature set.

4. The method of claim 3, further comprising:
applying a continuous optimization algorithm to the user query and the low-dimensional latent space to locate the region.

5. The method of claim 3, wherein the responsive compressed data is within a threshold to the user query in the low-dimensional latent space.

6. The method of claim 5, wherein the responsive compressed data is semantically similar to the user query.

7. The method of claim 4, wherein the continuous optimization algorithm is one of: a gradient descent algorithm, an adaptive moment estimation algorithm, and a Bayesian optimization algorithm.

8. The method of claim 1, further comprising:
concatenating the natural language text and the user query to form a concatenated string; and applying the LLM to the concatenated string.

9. The method of claim 1, wherein performing the autoencoding is by an autoencoder neural network.

10. The method of claim 1, further comprising:
identifying a first format of the first data; and
modifying the second data from a second format to the first format.

11. The method of claim 10, wherein the first format is one of a date format and a numerical value format.

12. The method of claim 1, wherein the first data is semi-structured data, collecting the diverse data comprises parsing the semi-structured data to generate structured data, and the aggregated data comprises the structured data.

13. The method of claim 12, further comprising:
extracting nested structures and attributes from the first data using hierarchical markdown parsing.

14. The method of claim 12, further comprising:
extracting nested structures and attributes from the first data using key-value parsing.

15. The method of claim 12, further comprising:
extracting structure elements from metadata attributes associated with the first data.

16. A system comprising:
a server comprising a processor;
a data repository in communication with the processor, and configured to store:
diverse data comprising first data from a first source and second data from a second source, the second source being disparate from the first source, the first data having a first attribute, and the second data having a second attribute,
compressed data in a low-dimensional latent space, and
a merged feature set for the low-dimensional latent space,
a large language mode (LLM), wherein the processor is programmed to apply the LLM to natural language text and a user query to generate an actionable insight; and
a server controller executable by the processor to perform operations comprising:
collecting the diverse data to generate aggregated data in a unified dataset,
performing an autoencoding of the aggregated data to generate the compressed data,
merging the first attribute and the second attribute to obtain the merged feature set,
selecting a response vector from the merged feature set in the low-dimensional latent space that is aligned with the user query, wherein the merged feature set is generated by:
collecting the diverse data to generate the aggregated data in the unified dataset,
performing the autoencoding of the aggregated data to generate the compressed data in the low-dimensional latent space, wherein the compressed data are representations of the aggregated data in the low-dimensional latent space, and
merging the first attribute and the second attribute to obtain the merged feature set for the low-dimensional latent space,
decoding the response vector into the natural language text,
executing the LLM on the natural language text and the user query to generate the actionable insight, and
presenting the actionable insight as a response to the user query.

17. The system of claim 16, wherein the operations further comprise:
selecting responsive compressed data in a region, the responsive compressed data being identified as similar to the user query based on the merged feature set.

18. The system of claim 17, wherein the responsive compressed data is within a threshold to the user query in the low-dimensional latent space.

19. The system of claim 16, wherein the operations further comprise:
applying a continuous optimization algorithm to the user query and the low-dimensional latent space to locate the region.

20. A non-transitory computer readable storage medium storing computer readable program code which, when executed by at least one processor, cause the at least one processor to perform operations comprising:
selecting a response vector from a merged feature set in a low-dimensional latent space that is aligned with a user query, wherein the merged feature set is generated by:
collecting diverse data to generate aggregated data in a unified dataset, wherein the diverse data comprises first data from a first source and second data from a second source, the second source being disparate from the first source, the first data having a first attribute, and the second data having a second attribute,
performing an autoencoding of the aggregated data to generate compressed data in the low-dimensional latent space, wherein the compressed data are representations of the aggregated data in the low-dimensional latent space, and
merging the first attribute and the second attribute to obtain the merged feature set for the low-dimensional latent space;
decoding the response vector into natural language text;
executing a large language mode (LLM) to the natural language text and the user query to generate an actionable insight; and
presenting the actionable insight as a response to the user query.
